(19) United States
(12) Patent Application Publication
(10) Pub. No.: US 2014/0138014 A1
(43) Pub. Date: May 22, 2014

(54) COMPOSITE FOAM PATTERN STRUCTURES

(71) Applicant: C.A.L.S., LTD., Miamisburg, OH (US)

(72) Inventors: Anil R. Chaudhry, Xenia, OH (US); Robert Dzugan, Cincinnati, OH (US); Brett S. Henderson, Yellow Springs, OH (US); Michael B. McMannon, Lebanon, OH (US); Travis D. Westendorf, Centerville, OH (US)

(73) Assignee: C.A.L.S., LTD., Miamisburg, OH (US)

(21) Appl. No.: 14/084,105

(22) Filed: Nov. 19, 2013

Related U.S. Application Data
(60) Provisional application No. 61/727,770, filed on Nov. 19, 2012.

(51) Int. Cl. B32B 37/24

(52) U.S. Cl. CPC B32B 37/24
USPC 156/77

(57) ABSTRACT

A composite structure comprises a closed-cell foam pattern having a skin, and a layer laminated to the skin of the foam pattern. The laminated layer may comprise a continuous layer, a discontinuous layer, a coating, a powder/particulate coating, another closed-cell foam pattern having a skin, etc. Also, the laminated layer may comprise a surface coating applied in-mold or post-mold to provide a composite structure that exhibits wear resistance, corrosion resistance, weather proofing, UV protection, and protection from delaminating or discoloring. A strengthening agent can be present throughout the foam.

### CROSS REFERENCE TO RELATED APPLICATIONS

This application claims the benefit of U.S. Provisional Patent Application Ser. No. 61/727,770 filed Nov. 19, 2012, entitled “COMPOSITE FOAM PATTERN STRUCTURES”, the disclosure of which is hereby incorporated by reference in its entirety.

### BACKGROUND

The present disclosure relates in general to composite structures, and in particular, to composite structures that incorporate foam pattern elements that form molded composite structures.

A polyol and an isocyanate can be combined to produce polyurethane foam. The foam is typically injected into a mold where the foam expands and cures to conform to the internal shape of the mold, thus producing a foam pattern. Depending upon the polyurethane formulation and the molding process, the resulting foam pattern can be flexible or rigid. Moreover, the foam pattern can be open-celled or close-celled. The open-celled foam produces structures that are usually pliable and soft. On the other hand, close-celled foam structures typically have varying degree of hardness, depending upon the density of the foam pattern. As such, close-celled foam patterns are often more rigid and strong compared to open-celled foam patterns. To the contrary, open-celled foam patterns are often more flexible and less dense than closed-cell foam patterns.

### BRIEF SUMMARY

According to aspects of the present disclosure, a method for creating a structure is disclosed. The method comprises mixing a first polyol and a first isocyanate to create a first foam pattern mixture and forming a first closed-cell foam pattern having a skin using the first foam pattern mixture. The method also comprises mixing a second polyol and a second isocyanate to create a second foam pattern mixture and forming a second closed-cell foam pattern having a skin using the second foam pattern mixture. The method still further comprises laminating the first foam pattern to the second foam pattern such that a portion of the skin that forms on the second foam pattern adheres to a portion of the skin of the first foam pattern.

According to further aspects of the present disclosure, a method for creating a tile is provided. The method comprises forming a veneer component having a predetermined shape defining a top of the tile. The method also comprises mixing a polyol and an isocyanate to create a foam pattern mixture and using the foam pattern mixture for forming a foam component defining a foam base of the tile. Particularly, the foam component is formed so as to be comprised of a rigid closed-cell structure having a skin. The method still further comprises laminating the veneer component to the skin (e.g., the outside of the skin) of the foam component. Moreover, the foam component is shaped so as to have at least one channel entirely through the foam component so as to provide a passageway under the veneer component and through the foam component.

According to further aspects of the present invention, another method for creating a tile is provided. The method comprises forming a veneer component having a predetermined shape defining a top of the tile. The method also comprises mixing a polyol and an isocyanate to create a foam pattern mixture and using the foam pattern mixture for forming a foam component defining a foam base of the tile. More particularly, the foam component is formed so as to be comprised of a rigid closed-cell structure having a skin. The method still further comprises laminating the veneer component to the skin (e.g., the outside of the skin) of the foam component. In this regard, the mixture forms a foam component such that the foam component has a wall that extends past the circumference of the veneer component. The wall has a top surface with a plurality of wells therein. In this regard, the circumference of the foam component is greater than the circumference of the veneer component.

According to still further aspects of the present invention, a method for creating a structure is provided. The method comprises inserting a first layer into a mold. The method also comprises mixing a first polyol and a first isocyanate to create a mixture and inserting the mixture into the mold such that the mixture forms a first closed-cell foam pattern having a skin that laminates to the first layer to form a composite foam pattern structure.

### BRIEF DESCRIPTION OF THE SEVERAL VIEWS OF THE DRAWINGS

FIG. 1 is a flow chart illustrating a process for creating a composite foam pattern structure, according to various aspects of the present disclosure;

FIG. 2 is an illustration showing a first closed-cell skinned foam pattern laminated to a second closed-cell skinned foam pattern to create a composite structure, according to various aspects of the present disclosure;

FIG. 3 is an illustration showing a square container for transporting temperature-sensitive supplies such as medical organs, fluids, pharmaceuticals or perishable items such as food supplies, drinks, or any other item which needs to be kept in a temperature controlled environment, wherein the container is made using the process of FIG. 1, according to various aspects of the present disclosure;

FIG. 4 is a cross-sectional view of the square container of FIG. 3, according to various aspects of the present disclosure;

FIG. 5 is a kidney-shaped container for transporting temperature-sensitive supplies such as medical organs, fluids, pharmaceuticals or perishable items such as food supplies, drinks, or any other item which needs to be kept in a temperature controlled environment, wherein the container is made using the process of FIG. 1, according to various aspects of the present disclosure;

FIG. 6 is a cross-sectional view of the kidney-shaped container of FIG. 5, according to various aspects of the present disclosure;

FIG. 7 is an exemplary Emergency Medical Services (EMS) backboard constructed as a composite structure that incorporates at least one foam pattern element, according to aspects of the present disclosure;

FIG. 8 is a side profile of the backboard of FIG. 7;

FIG. 9 is an exemplary tile constructed as a composite structure that incorporates at least one foam pattern element according to aspects of the present disclosure;

FIG. 10 is a view of the underside of an exemplary tile, illustrating an embodiment having passageways through a foam portion of each tile, according to aspects of the present disclosure;

FIG. 11 is a partial view of two adjacent tiles illustrating an exemplary approach to interconnect the adjacent tiles, according to aspects of the present disclosure herein.

FIG. 12 is a perspective view of a grout connector above adjacent tiles, according to illustrative aspects of the present disclosure herein;

FIG. 13 is a view of the tiles of FIG. 12 with the grout connector snapped into place holding the adjacent tiles together, according to aspects of the present disclosure; and

FIG. 14 is a view of adjacent tiles, illustrating the use of connecting pins to hold adjacent tiles together so that conventional grout can be used between adjacent tiles, according to aspects of the present disclosure.

### DETAILED DESCRIPTION

According to various aspects of the present disclosure, structures are constructed, which include at least one foam pattern as a component of an overall composite assembly (referred to herein generally as a composite foam pattern structure). In general, the composite foam pattern structures described herein are strong, wear-resistant, extremely light weight, custom molded shapes that can have surface finish details and insulating properties for a variety of applications in construction, transportation, medical, military and other commercial fields.

In a first illustrative example, foam pattern sheets (each comprising a closed-cell foam pattern having a skin) are laminated together to provide overall materials that are light weight and strong, exhibiting favorable insulating properties and strong resistance to deflection from loading. In a second illustrative example, a layer is laminated to at least one outer surface of a closed-cell foam pattern having a skin. Each layer may comprise for instance, a continuous layer, a discontinuous layer, a coating or a powder/particulate coating, examples of which are described in greater detail herein. Moreover, the structures and techniques of the first illustrative example and the second illustrative example can be combined as required by a specific application.

As will be described in greater detail herein, the overall foam pattern structures may be net-shape molded shapes, i.e., by forming a composite material defining a molded shape. In alternative examples, the overall foam pattern is produced and is subsequently worked, e.g., via cutting, milling etc., to achieve a desired end shape.

The foam may be produced with the materials and processes disclosed in U.S. Pat. No. 7,958,932 to Chaudhry, the entirety of which is hereby incorporated by reference and U.S. Published Patent Application No. 2012/0007266 by Chaudhry, the entirety of which is hereby incorporated by reference.

All Foam Laminated Structure

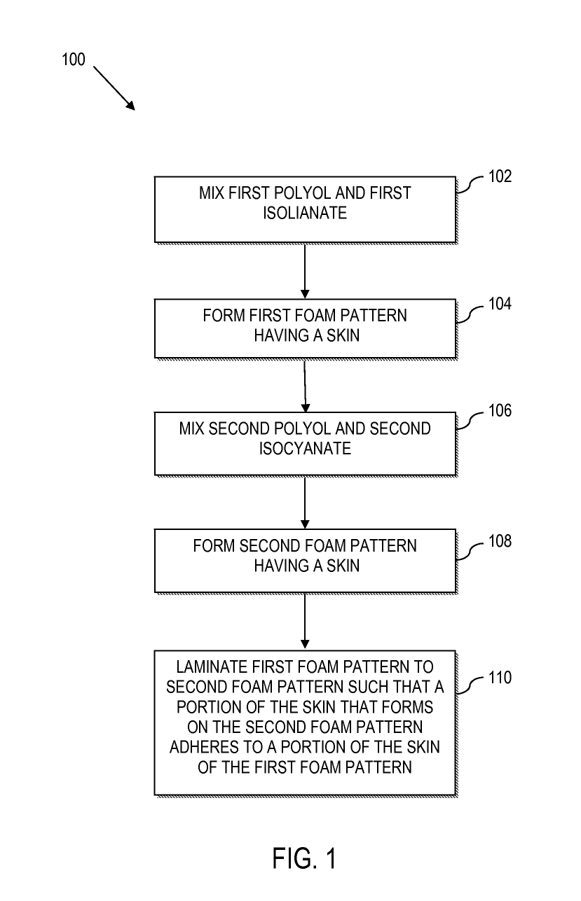

Referring now to the drawings and in particular to FIG. 1, a method 100 is illustrated for constructing a laminated foam structure. The method 100 comprises mixing at 102, a formulation comprising at least a first polyol and a first isocyanate. The formulation is used to create a first closed-cell foam pattern having a skin at 104. The method 100 also comprises mixing at 106, a formulation comprising at least a second polyol and a second isocyanate. The formulation is used to create a second closed-cell foam pattern having a skin at 108. The first foam pattern is laminated to the second foam pattern at 110, such that a portion of the skin that forms on the second foam pattern adheres to a portion of the skin of the first foam pattern.

In a first illustrative example, the mix at 102 and the mix at 106 are carried out in a single combined process. As an example, the mixture for forming the first and second foam patterns may be prepared using a Reaction Injected Molded (RIM) process. In this illustrative implementation, an isocyanate component is maintained in liquid form in a temperature controlled isocyanate feed tank and a polyol component is maintained in liquid form in a temperature controlled polyol feed tank. A first supply line carries liquid isocyanate from the isocyanate feed tank to a first precision metering/feeding device that meters the isocyanate to a mixhead device. Similarly, a second supply line carries liquid polyol from the polyol feed tank to a second precision metering/feeding device that meters the polyol to the mixhead device. The isocyanate and polyol enter a chamber within the mixhead at high pressure where they are mixed before being injected into a corresponding mold having die cavity shaped to correspond to the desired pattern shape. The mixture may further comprise other additives that are mixed with the polyol component and isocyanate component, such as a skin hardening agent, a catalyst, other additives, or a combination thereof. Still further, other materials such as fibers, powders, particulates, mat, fabric or continuous sheets, etc. can be added to the mixture, e.g., in the mold.

Thus, the mix at 102 and the mix at 106 can be carried out with the mixture capability of the mixhead of the RIM machine such that the first and second foam patterns are formed from the same overall formulation. That is, the mixhead of the RIM machine performs the mix at 102 and material from the mixhead is used to form the first foam pattern at 104. The material remaining (and optionally the material subsequently metered into the mixhead) is mixed at 106 and that mixture is used to form the second foam pattern at 108.

Alternatively, the mix at 102 and the mix at 106 can be carried out in separate processes so as to allow a change in the overall formulation when forming the second foam pattern at 108. That is, by changing the formulation, e.g., by changing the recipe for the mixture, the properties of the first and second foam pattern can be varied, e.g., by varying the thickness of the formed skin, by changing the overall density of the foam patterns, etc.

The foam material is inserted (e.g., hand poured, robotically poured, injected, etc.) into a cavity of a mold, where it expands slightly to fill the cavity of the mold. The foam is allowed to set up so as to harden (i.e., cure) over time to form the corresponding foam pattern at 104 and 108. A release agent can be used to coat the cavity of the mold for easier release of the pattern from the mold, if necessary.

The foam pattern is removed from the cavity of the mold and is allowed to cool. The resulting molded foam pattern exhibits a film-like surface that is free from surface-connected open pores of the polyurethane foam. The thickness of the outer surface of the foam pattern will likely depend upon processing conditions and the geometry of the corresponding pattern. However, the skin (i.e., outer surface) may be typically less than 0.001 inches (0.00254 centimeter) thick or thicker, depending upon the application. Moreover, the resulting pattern can be formulated to have an aggregate pattern density that exhibits sufficient stiffness, rigidity and smooth surface characteristics for a particular intended application.

Moreover, depending upon the application, a single mold can be used to form the first foam pattern at 104 and the second foam pattern at 108. For instance, in an application requiring a laminated sheet, a single mold may be utilized to form a large foam pattern sheet that is subsequently cut into sections.

Still further, a first mold can be used to form the first foam pattern at 104 and a different mold (of similar or different shape from the first mold) can be used to form the second foam pattern at 108. This allows the first and second foam patterns to have different geometries, and also allows the first and second foam patterns to be formed at the same or different times.

As another illustrative example, the first foam pattern can be constructed as noted above. The first foam pattern can then be installed in a mold (e.g., a surface of the first foam pattern forms an interior surface of the mold) and the second foam pattern mixture can be inserted into the mold, e.g., via injection, pouring, etc. As the second foam pattern mixture cures into the second foam pattern, the second foam pattern will form a skin that laminates to the skin of the first foam pattern in the mold. Thus, the outer (skin) layers and the intermediate layers are closed-cell foam. However, the skin layers have different properties than their respective intermediate layers.

Laminated Foam Structures

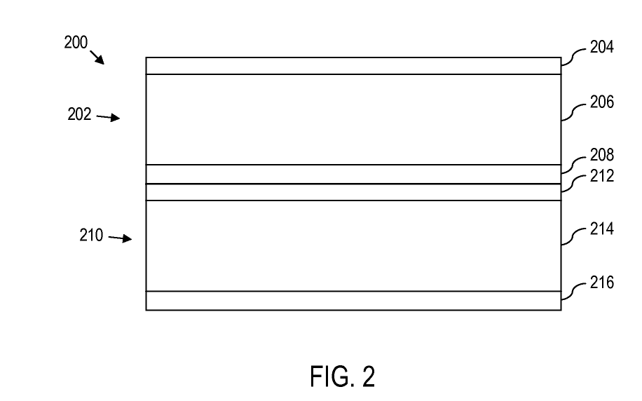

Referring to FIG. 2, an example is provided of laminating foam pattern sheets according to various aspects of the present disclosure. The laminated foam pattern sheets may be constructed using the method of FIG. 1, for example. A composite structure 200 includes a first foam pattern 202 having a first skin layer 204, a closed-cell intermediate layer 206 and a second skin layer 208. A second foam pattern 210 includes a first skin layer 212, an intermediate layer 214 and a second skin layer 216. The first foam pattern 202 is laminated to the second foam pattern 210 such that at least a portion of the second skin layer 208 of the first foam pattern 202 adheres to a portion of the first skin layer 212 that forms on the second foam pattern 210. In this regard, the composite structure is not consistent throughout a cross-section taken through its thickness, despite possibly being formed from a common isocyanate and polyol mixture. More particularly, the composite structure 200 is actually a sandwich of four skin layers 204, 208, 212 and 216 and two intermediate closed-cell layers 206 and 214, even when the first foam pattern 202 and the second foam pattern 210 are constructed from structurally identical material, and as identical parts. That is, the “sandwich” of layers occurs even where the first foam pattern 202 has structural properties that are similar to the second foam pattern 210. Moreover, the lamination of adjacent skin layers 208, 212 provides strength and rigidity that could not be achieved by a single mixture of the same overall thickness.

The technique described above with reference to FIG. 1 and FIG. 2 can be extended to any number of layers, shapes and formulations as the specific example dictates.

By way of illustration, the above-technique can be expanded to laminate multiple layers. For instance, a first previously formed foam pattern sheet can be placed in a top mold half, a second previously formed foam pattern sheet can be placed into a bottom mold half, and a mixture of polyol and isocyanate can be inserted between the first and second foam patterns to form a middle foam pattern sheet, thus producing a three sheet construction. Because each foam pattern sheet skins, the resulting construction includes from top down: the top foam pattern sheet having three layers including a skin layer, a closed cell intermediate layer and a skin layer; the middle foam pattern sheet having three layers including a skin layer, a closed cell intermediate layer and a skin layer; and finally the bottom foam pattern sheet having three layers including a skin layer, an intermediate closed-cell layer and a skin layer. Notably, this construction results in two sets of adjacent skin layers within the thickness of the combined sheets.

Also, as noted in greater detail herein, foam patterns can be formed independently, then joined together. For instance, a separate foam patterns can be glued together, such as by using an adhesive, the foam pattern mixture, etc. The combined foam patterns can then be coated, such as by applying a spray coating.

Foam patterns as described herein are rigid polyurethane patterns that exhibit a closed-cell structure and a smooth, continuous and unbroken skin. That is, the skin exhibits a film-like surface that is free from surface-connected open pores. Moreover, the skin may have an applied texture due to intentional features in the mold to affect the surface of the foam pattern. Regardless, the skin is continuous and unbroken.

Printed on Foam Pattern

The film-like surface of the foam structures, which is free from surface-connected open pores, facilitates the ability to print directly on the foam patterns described herein. For instance, a foam pattern may be formed an into end user product by molding the foam pattern into a desired shape, e.g., the shape of a floor tile. After the foam has cured into a rigid structure, a printer applies printing to the skin of the foam pattern to provide the desired feature. For instance, in a foam floor tile, a faux finish may be implemented by printing a stone, metal, plastic, marble, slate, ceramic, concrete, or other desired look onto the surface of the foam pattern. The realism of the faux finish may be enhanced by molding associated textural features directly into the foam pattern. Moreover, where the end product is a floor tile, a faux grout can be printed onto the tile, e.g., around the edges, such that as the tiles are abutted against one another on the floor, the faux grout gives the visual appearance of a grouted floor. Here, a coating is applied over the ink printed onto the foam pattern to prevent the image from fading, washing away, discoloring or otherwise changing. As such, a composite structure comprises one or more layers of foam, a layer of printed indicia, and a layer of coating.

Also, the combined foam patterns can themselves be a component of a further process that builds a composite structure incorporating a foam pattern, examples of which are described in greater detail below.

Laminated Foam Pattern

In yet another illustrative example, an overall assembly includes at least one intermediate foam pattern layer (i.e., a foam pattern intermediate layer), and at least one outer layer adjacent to the intermediate layer. The outer layer(s) may comprise any number of surfaces, substrates, compositions, or combinations thereof. The foam pattern may comprise a single layer of skinned, closed-cell foam material or a foam pattern built by laminating two or more skinned, closed-cell foam patterns, as described more fully above.

By way of illustration, and not by way of limitation, an outer layer may comprise a continuous layer (e.g., a solid layer) that is laminated to a surface of a foam pattern intermediate layer. The continuous layer may comprise any suitable solid material, which is selected for the desired properties of the intended application. For instance, the outer layer may comprise a veneer, laminate, plastic, metal, wood, concrete, ceramic, porcelain, stone or other material that forms a continuous layer over the intermediate layer.

Moreover, because of the strength and rigidity of the foam pattern layer(s) as set out herein, finished products can be made using foam in combination with a veneer as a substitute for a conventional product. For instance, ceramic floor tiles, wall boards, roof tiles, decking planks and other building materials can be replaced with products that are constructed from one or more layers of foam material as set out herein, with an outer laminated veneer layer, which may be comprised of plastic, metal, wood, concrete ceramic, porcelain, stone or other material. The veneer layer may even be a layer of foam material, e.g., a foam material that has been printed with an optional protective coating applied over the print layer. Thus for instance, whereas a traditional floor tile may comprise thick marble, granite, travertine, limestone, slate, or other material, resulting in a heavy and expensive product, a comparable product can be produced using a foam base with a veneer of marble, granite, travertine, limestone, slate, or other material, thus reducing the cost of the product, decreasing the weight of the product yet producing a strong and durable product. Thus, less of the expensive tile material (e.g., marble, granite, travertine, limestone, slate, etc., is used per tile).

Further, the continuous layer may be flexible or rigid, depending upon the desired properties required for a given application. In this example, the continuous layer can be inserted into a mold and a mixture of foam pattern material can be inserted into the mold. As the mixture expands and cures, it acts as a glue to laminate the continuous layer directly to the foam pattern. As such, no additional glue or other material is required to laminate the continuous layer to the foam pattern.

As another illustrative example, the outer layer may comprise a discontinuous layer that is laminated to a surface of a foam pattern intermediate layer. That is, the outer layer may be porous or the outer layer may otherwise form one or more breaks in the continuity of covering a surface of the foam pattern intermediate layer. For instance, the outer layer may comprise a layer of cloth (e.g., a woven or non-woven fabric; glass, carbon, or wire mesh; a fibrous or stranded material, etc.). In a manner analogous to that described above, the discontinuous layer is placed in a mold and the mixture is inserted into mold. Where the outer layer comprises a mesh or other non-continuous material, the foam pattern will fill (penetrate through) the interstices, voids, holes, web or mesh openings, etc., and bond around the outer layer so as to form a unitary structure (e.g., a structure that is essentially integral). Further, the discontinuous layer may be flexible or rigid, depending upon the desired properties required for a given application. Thus, again, if the foam pattern mixture is applied to the discontinuous material in the mold, as the mixture cures, it adheres in the mold due to the adhesive characteristics of the mixture and thus laminates to the discontinuous material. Accordingly, no additional glues, adhesives, chemicals or other agents are required to construct the laminated composite foam pattern structure.

Moreover, by taking advantage of the properties of the mixture and laminate, net-shape molded shapes can be created, i.e., the methods herein form composite material structures while producing molded shapes. This can reduce finish work and other labor intensive steps to manufacturing a finished article.

As yet another illustrative example, the outer layer may comprise a coating that is applied to a surface of a foam pattern intermediate layer. The coating can comprise any suitable composition, such as paint, varnish, enamel, lacquer, ceramic, or other suitable coating. For instance, a foam pattern intermediate layer can be spray coated to provide a hard shell around the foam pattern. The coating material may also be applied in-mold, e.g., the coating material is sprayed or applied to the inner surface of the mold, foam is injected or poured into the mold, and as the foam expands to fill the mold it bonds to the coating material providing a fully coated, fully cured and fully molded foam pattern, all in one process step. The coating may alternatively be applied to the foam pattern intermediate layer by dipping, brushing on, etc. In this example, the coating may be applied once the foam pattern cures and hardens.

As yet still another illustrative example, the outer layer may comprise a discrete layer, e.g., particles, such as loose particulates, a powder, grain, etc., that are applied to a surface of a foam pattern intermediate layer. The particles may be applied in a thick coating so as to form a substantially continuous layer, or the particles can be scattered so as to form a discontinuous layer. Again, the particulates may be applied to a surface of a mold. The foam pattern mixture is then applied to the mold. As the mixture expands and cures, it acts as a glue to laminate the particulates directly to the foam pattern. As such, no additional glue or other material is required to laminate the continuous layer to the foam pattern.

Alternatively, the outer layer can be a foam pattern itself, as described more fully above. By forming a first foam pattern having a skin and inserting the formed foam pattern in a mold, a foam mixture can be inserted into the mold to form the intermediate layer. As the intermediate layer forms, the skin of the outer layer will adhere the skin of the intermediate layer. As disclosed, the outer layer (and its skin) is made before the intermediate layer; however, in all aspects of the disclosure, the intermediate layer may be made before the outer layer. Here, a foam pattern mixture can be brushed, sprayed or otherwise applied to the skin of one foam pattern.

According to still further aspects of the present disclosure, composite structures can be manufactured using polyurethane foam such that items are dispersed throughout the foam matrix i.e., fibers, powders, particulates, mat, fabric, or continuous sheets can be within the foam itself in addition to or in lieu of being in the lamination layer or surface of the foam.

According to still further aspects of the present disclosure, the composite structure can be worked (e.g., by sanding, drilling, tapping, etc.) so as to define the features, attachments or modifications necessary for a particular application and required functions. Still further, tooling such as bolts, clamps, fitting devices, taps, etc., can be embedded in the composite structure. The tooling may be integrated into the composite structure either post-molding or in-molding.

In this regard, the foam sheets are not homogeneous (i.e., the foam sheets are self-skinning). Thus, even when the composite structure comprises two thin layers of polyurethane foam, on each side of the meeting of the two layers, there are thin dense layers like thin sheets of laminates due to the skinning. As such, a composite structure of an intermediate foam layer, a first (outer) foam layer on a first side of the intermediate foam layer, and a second (outer) foam layer on a second side of the intermediate foam layer opposite of the first side, results in two layers of laminates on the top surface of the intermediate foam and two layers of laminates on the bottom surface of the intermediate foam, giving the structure stiffness, rigidity, and strength. This approach can be extended to add additional layers of foam sheets. Each intermediate foam sheet adds two laminates due to the skinning effect on each face of the sheet. Each additional sheet can be configured to add strength as the application dictates. This provides a structure that is light weight, yet realizes high stiffness and load carrying capability.

According to certain aspects of the present disclosure, as the foam pattern intermediate layer gels, the material of the intermediate layer acts as a “superglue” providing an adhesive property that allows an extremely broad cross section of products to adhere to the intermediate layer without any intervening layers. That is, as the chemical reaction takes place between the components of the foam pattern intermediate layer, the intermediate layer will bond to the adjacent surface of the outer layer giving the overall composite structure stiffness and strength as much as a distinct laminate material (e.g., such as veneer, plastic or sheet metal).

Moreover, in applications where an outer layer is provided on both sides of a foam pattern intermediate layer, each outer layer on opposite sides of the foam pattern intermediate layer need not comprise the same materials. Still further, the outer layer(s) may each comprise an assembly of one or more layers themselves and/or the foam pattern intermediate layer may comprise one or more laminated foam pattern layers, thus allowing the construction of complex structures.

By assembling a structure comprised of an intermediate layer of foam and at least one outer layer, structures can be custom tailored to a specific application, such as to exhibit high strength with minimal deflection, etc. Moreover, the outer layer may be coated or uncoated, dyed, painted, or otherwise treated for structural or aesthetic purposes, as noted more fully herein.

Still further, because the foam pattern is based upon a mixture, certain materials such as carbon fiber, glass fiber, etc., can be injected or otherwise directly integrated into the mixture in addition to or in lieu of laminating a separate layer to the surface of the foam pattern. Thus for example, strengthening agents can be provided throughout the foam.

Still further, as noted in greater detail herein, surface coatings can be applied in-mold or post-mold to provide a composite foam pattern structure. The surface coating can be used to form an overall composite structure that exhibits wear resistance, corrosion resistance, weather proofing, ultraviolet (UV) protection, and protection from delaminating or discoloring.

### Example

### An Insulated Structure

As mentioned above, objects (e.g., mesh, a vacuum insulated panel, particulates, etc.) may be inserted or embedded in a multi-layer (multi-wall) structure, e.g., between the outer layer and the intermediate layer. While this may be used for panels and any other desired products, the concepts are best understood for purposes of discussion herein, in the context of a container.

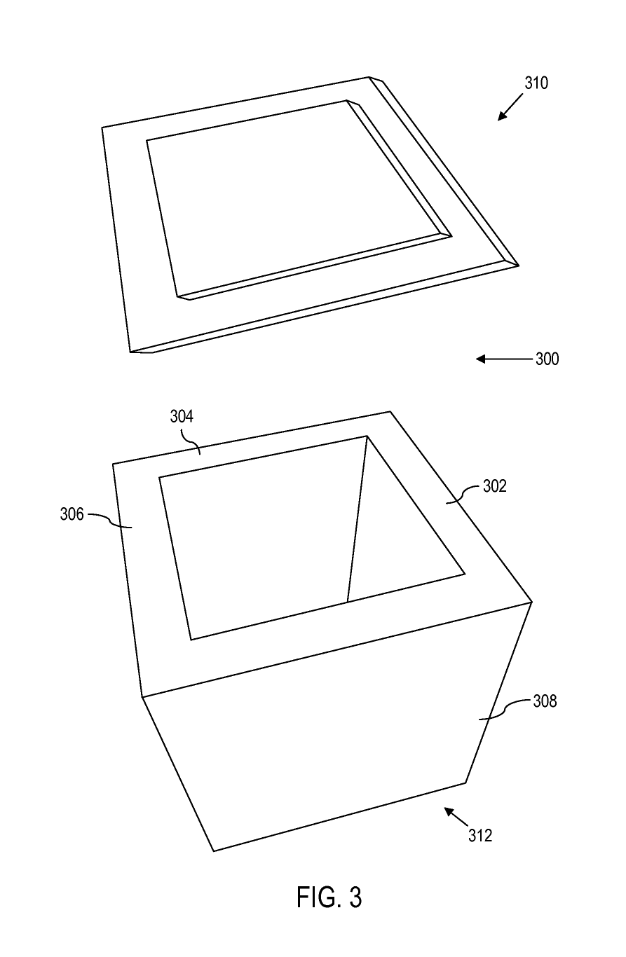

For example, FIG. 3 illustrates a container 300 for transporting temperature-sensitive supplies such as medical organs, fluids, pharmaceuticals or perishable items such as food supplies, drinks, or any other item which needs to be kept in a temperature controlled environment, that can be made following the process(es) outlined above.

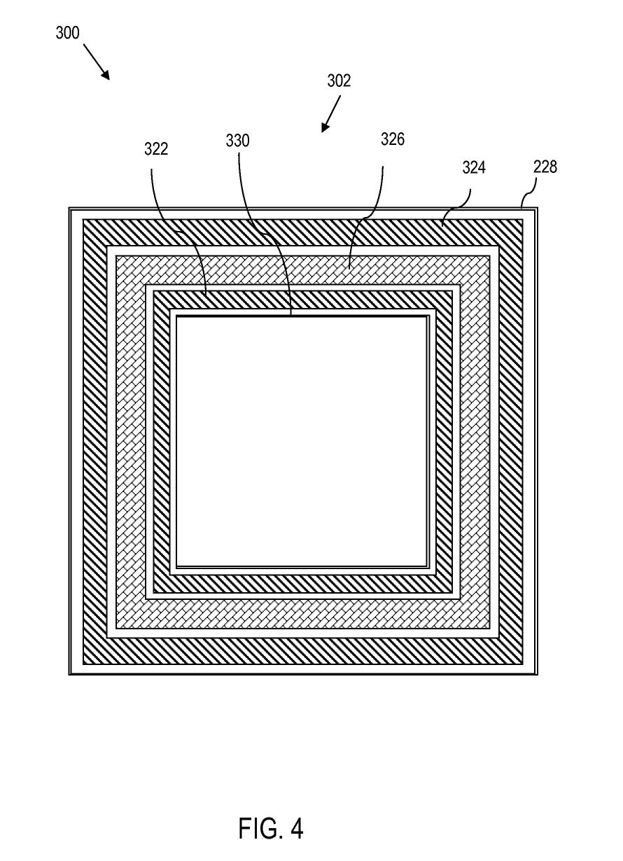

The exemplary container 300 has four walls 302, 304, 306, 308, a top 310, and a bottom 312. A cross-section showing the internal composition of the four walls 302, 304, 306, 308 is shown in FIG. 4. Each wall (302 as shown in FIG. 4) has an inner wall 322 of foam pattern material comprising an intermediate closed-cell layer (horizontal shading) and a skin on each surface (non-shaded). The container also includes an outer wall 324 of foam pattern material comprising an intermediate closed-cell layer (horizontal shading) and a skin on each surface (non-shaded).

Between the inner wall 322 and the outer wall 324 is a set of overlapping vacuum insulated panels 326 (VIPs illustrated with brick cross-hatch). The VIPs may be integrated into the container in any effective way including, but not limited to assembling the walls then inserting the VIPs into the open space between the panels, or by creating the outer wall and inner wall such that the skins of the inner and outer walls adhere to the VIPs directly; etc.

A phase change material (PCM) can be placed between walls in addition to the VIPs in the form of ice packs or frozen packs or the PCM material itself can be mixed into the foam as an additive to provide the needed thermal properties i.e., temperature control or least temp variance over extended period of time.

An outside surface of the outer wall 324, an inside surface of the inner wall 322, or both may also include a coating 328, 330 (respectively) to increase resistance to impact, abrasion, corrosion, weather, chemicals, etc. For example, the coating may be an ISO (International Standards Organization) coating and resin at one millimeter to create a hardness (Shore) of about 75D in the exterior of the container, interior of the container, or both. The coating can be applied in-mold (i.e., applied to the mold and when the foam is added to the mold, the coating adheres to the polyurethane foam) or post-mold. Another suitable coating is an elastomeric polyurethane.

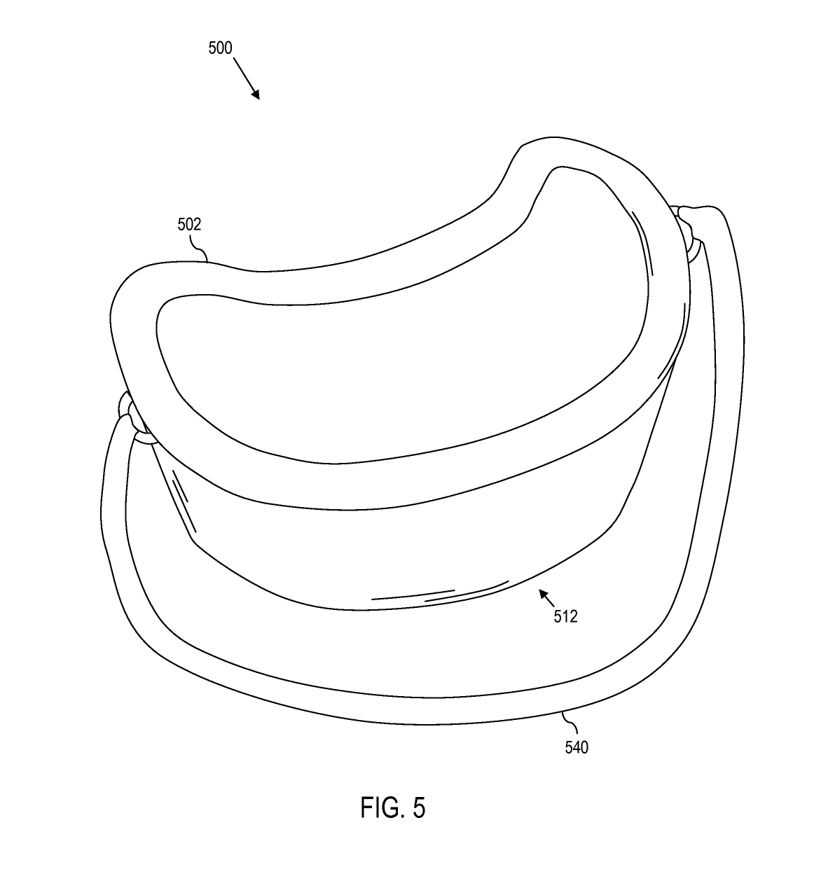

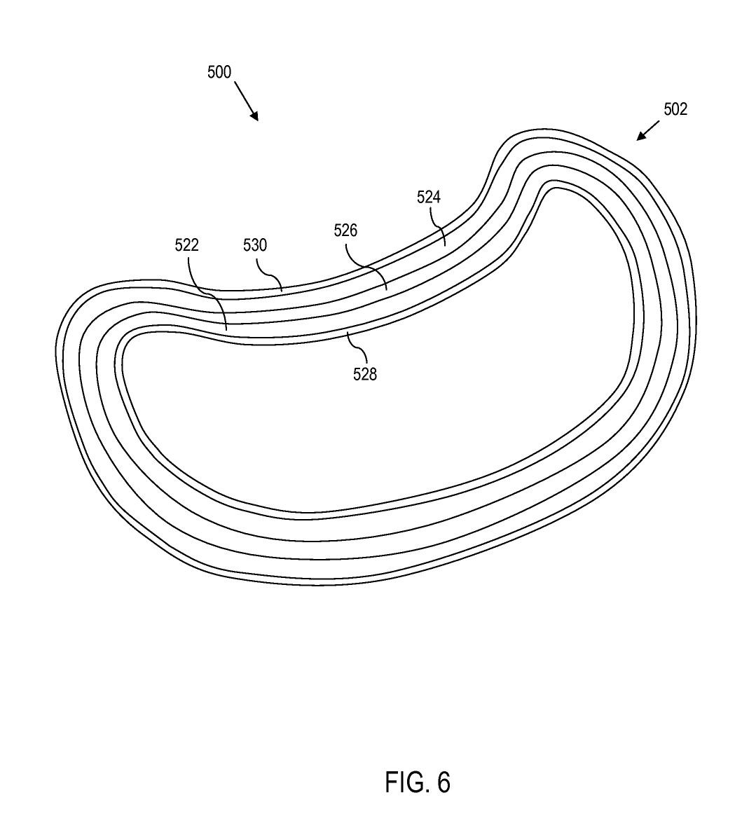

Another embodiment of the container is shown in FIGS. 5 and 6 as a kidney-shaped container. The exemplary kidney-shaped container 500 has a kidney-shaped wall 502, a top (not shown), and a bottom 512. A cross-section showing the internal composition of the wall 502 is shown in FIG. 6. The wall has an inner wall 522 and an outer wall 524, both of which are a closed-cell structure foam having a skin in a manner analogous to that described with reference to the example of FIGS. 3 and 4. Between the inner wall 522 and the outer wall 524 is a set of overlapping vacuum insulated panels 526 (VIPs). As with the container of FIGS. 3-4, the VIPs may be integrated into the container in any effective way including, but not limited to assembling the walls then inserting the VIPs into the open space between the panels or creating the outer wall and inner wall such that the skins of the inner and outer walls adhere to the VIPs directly; etc.

An outside surface of the outer wall 524, an inside surface of the inner wall 522, or both may also include a coating 528, 530 (respectively) to increase resistance to impact, abrasion, corrosion, weather, chemicals, etc. in a manner analogous to that described above with reference to FIGS. 3 and 4. For example, the coating may be an ISO (International Standards Organization) coating and resin at one millimeter to create a hardness (Shore) of about 75D in the exterior of the container, interior of the container, or both in a manner analogous to that described above for the product of FIGS. 3 and 4. The coating can be applied in-mold (i.e., applied to the mold and when the foam is added to the mold, the coating adheres to the polyurethane foam) or post-mold. Another suitable coating is an elastomeric polyurethane.

Further, the kidney-shaped container includes a strap 540 so a person may carry the container hands-free. That strap 540 in FIG. 5 (or the fibers of the strap) may also be encapsulated in foam to increase durability.

The above structures provide an insulator with a high strength to weight ratio and high insulating properties.

Example Long Rigid Board

Techniques herein can be used to make long, thin, rigid structures for a wide number of components and products. While not limiting, the concepts of is illustrated in the context of an emergency medical services (EMS) backboard.

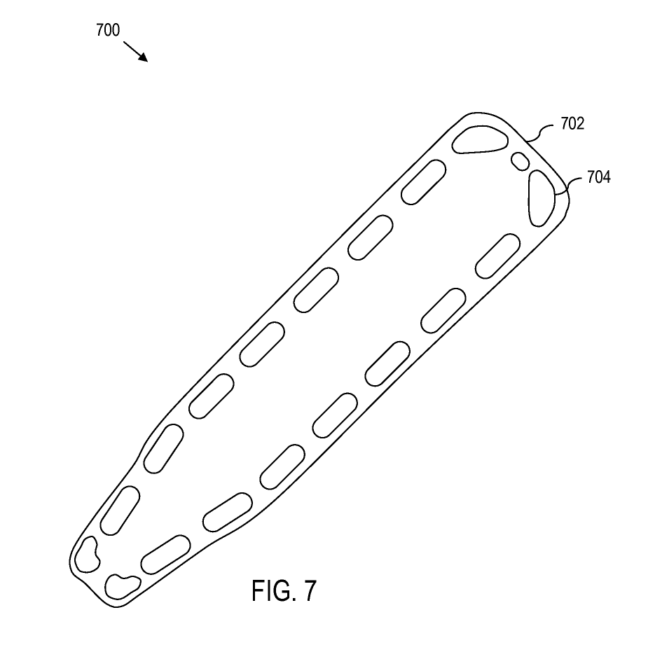

Referring to FIG. 7, an emergency medical services (EMS) backboards 700 is illustrated. The backboard 700 includes a composite foam body 702 formed so as to take on the general shape of a backboard having a plurality of through handle grips 704 spaced around the outer periphery of the body 702.

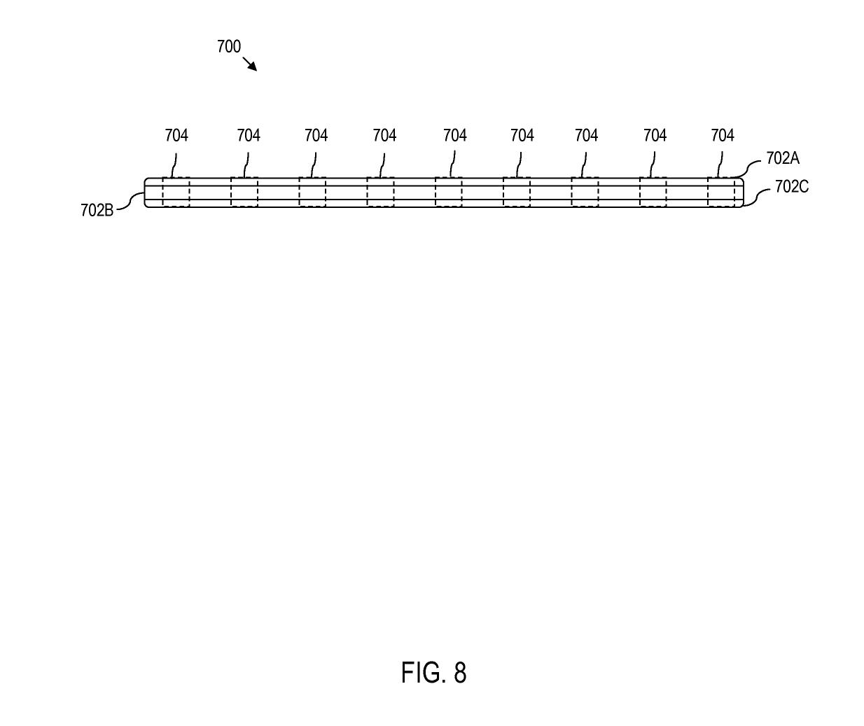

Referring to FIG. 8, in a first illustrative example, the composite structure comprises at least three layers, including a top laminate layer 702A, a foam layer 702B and a bottom laminate layer 702C. The composite foam body 702 may be manufactured as a net-shape molded product by inserting the top laminate 702A and the bottom laminate 702C into a mold shaped to the dimensions of the body. The polyurethane foam as described more fully herein is inserted (e.g., poured, injected, etc.) into the mold between the laminates 702A, 702C. As the foam cures, the foam material expands thus forming the backboard shape. Moreover, as the foam skins, the skin surface of the foam self-laminates to the laminates 702A, 702C. The mold can include inserts to define the handles 704, thus forming a near finished product in a single operation.

In alternative exemplary implementations, fiberglass or another suitable strengthening material is installed in one or more locations about the mold before the foam is poured or otherwise injected in to the mold. For instance, fiberglass can be used to reinforce and further strengthen areas around the handles, 704, the ends and/or edges of the backboard 700, etc.

As such, regardless of implementation, the backboard 700 can be manufactured quickly and consistently. Using the above technique, a board can be manufactured that is lighter, stiffer, and stronger than a corresponding wood and polymer equivalent boards. A polymer board for instance shows five inch (12.7 centimeter) flex compared to an inch (2.54 centimeter) flex for composite foam boards made by the disclosed method. Moreover, using the above technique, a board can be manufactured that exhibits reduced weight and cost compared to conventional products made using rotational molding or rotocasting processes.

Example Tile

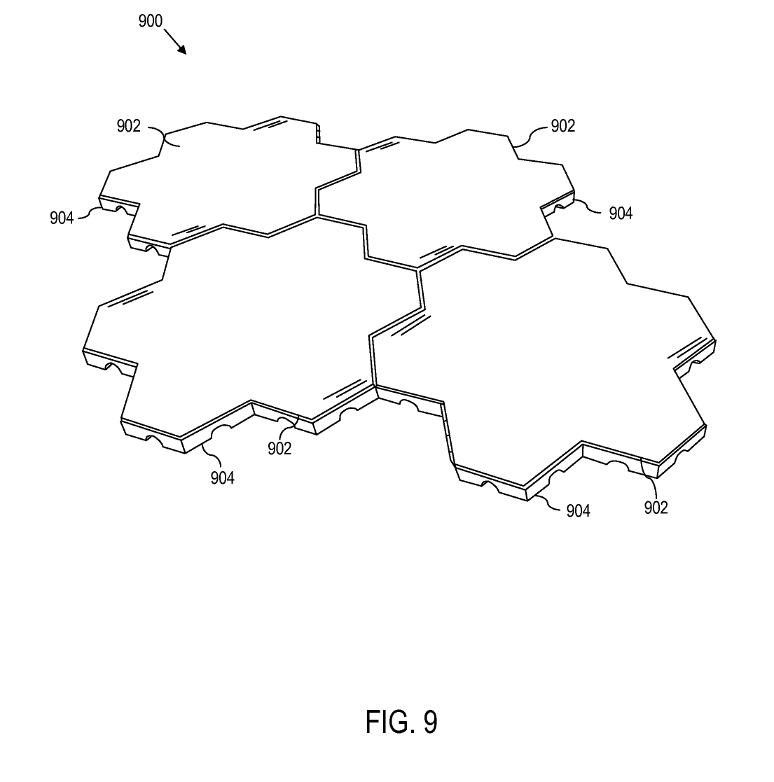

Referring to FIG. 9, according to various aspects of the present disclosure herein, a thermal tile 900 is disclosed. The thermal tile 900 includes in general, a veneer component 902 that overlies a foam component 904. In this regard, the veneer component 902 defines a tile top, i.e., the top surface of the tile 900, and the foam component 904 defines the foam base of the tile 900.

The veneer component 902 may comprise any veneer. For instance, a suitable veneer may comprise stone, metal, plastic, concrete, ceramic, porcelain or other materials, further examples of which are set out herein. The veneer component 902 may also comprise a veneer of foam material. In this regard, the foam material has a skin facilitates applying a print layer to the foam material. As such the surface of the foam veneer may take on any desired aesthetic.

The foam component 904 may be a single foam layer, or the foam component 904 may be comprised of multiple layers, e.g., using the layer and laminating techniques described more fully herein. For instance, the foam component 904 may be assembled by laminating two or more layers of foam pattern as described with reference to FIGS. 1 and 2.

In an illustrative implementation, the veneer component 902 can be inserted into a mold, and a foam mixture can be poured, injected or otherwise placed inside the mold. As the foam cures, the volume inside the mold forms the foam component 904, and the foam component 904 will laminate and adhere to the veneer component 902 without requiring additional glue, adhesives or other forms of additional components.

As illustrated in FIG. 9, multiple instances of the tile 900 connect, abut or otherwise join to form a larger whole, e.g., a floor or covered area. For instance, in certain illustrative implementations, each tile 900 is a polygon in shape. More particularly, each tile 900 may comprise a combination of convex and concave angles such that each tile 900 has a plurality of “arms”, recesses between adjacent arms, or other features. In the embodiment of FIG. 9, the shape of each tile 900 includes six arms that extend out from a central portion, which allows individual tiles 900 to lock together thus creating an inherently stable structure. However, in practice, other shapes, including rectangles, triangles, other polygons, shapes with curved portions, etc., may be utilized.

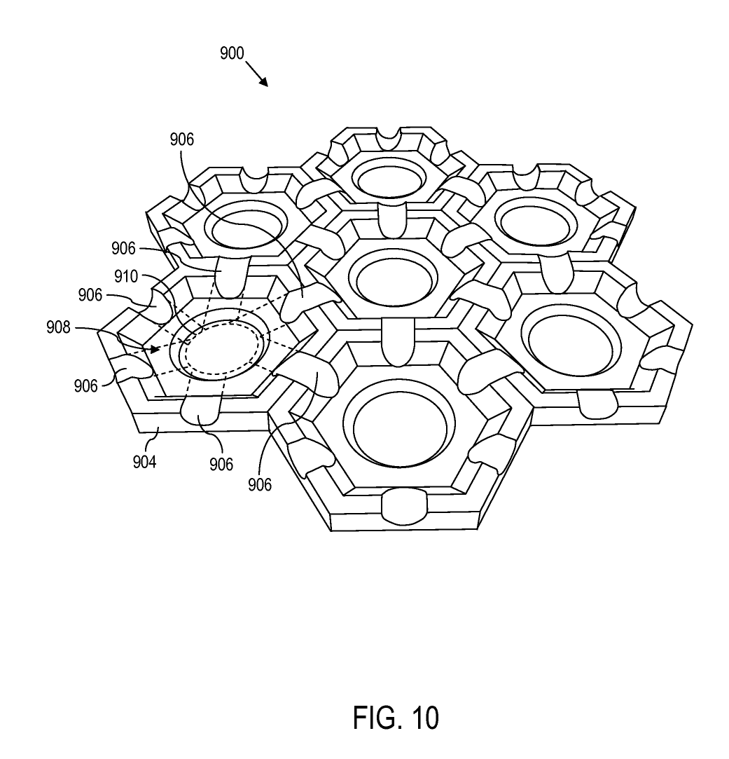

Referring to FIG. 10, in certain illustrative implementations, each tile 900 includes a foam component 904 that defines at least one channel. For instance, as illustrated, each instance of a tile 900 includes a plurality of through channels 906 that each open or otherwise intersect in a common area 908. The common area 908 is a space within the interior of the foam component 904. The foam component 904 may also include other features, such as a pad 910. The interconnected passageways are only illustrated with dashed lines in one of the tiles 900 for sake of clarity of the illustration. In the illustrated example, each face of the foam component 904 may include a channel 906 such that any way adjacent tiles 900 are laid together, there is at least one through passageway through both tiles 900.

In practice, all of the tiles 900 include passageways that internally interconnect. Moreover, the through channels 906 of adjacent connected tiles 900 connect and join together to make a through passageway that creates a network, maze, labyrinth or other series of omni-directional interconnections that allow continuous and uninterrupted passageways through multiple interconnected tiles 900. The combination of through channels 906, common areas 908 and optional extension wells 910 across multiple connected tiles 900 permits the tiles 900 to be used over conduit, wires, pipes, uneven surfaces or other features within an environment.

By way of illustration, and not by way of limitation, omni-directional channels 906 are formed in the foam component 904, e.g., via molding, so that through passageways will align properly for water lines regardless of the way that the individual instances of the tiles 900 are placed together. For instance, the channels 906 for use with water lines may be ¾ inch (1.905 centimeters) deep to allow for ½ inch (1.27 centimeter) water lines and still have some tolerance for shaving off thickness for leveling purposes. If no leveling is required, then the channels would fit ¾ inch (1.905 centimeters) tubing. For applications that require ¾ inch (1.905 centimeter) conduit, then the overall thickness of the tiles 900 can be adjusted accordingly, e.g., to have an overall thickness of approximately 1¼ inches (3.175 centimeters) thick (at least for implementations of the veneer component 902 as a stone veneer). In some instances, it may be suitable to use a veneer component 902 implemented as a stone veneer that is approximately ¼ inch (0.635 centimeter), or even as thin as ⅛ inch (0.3175 centimeters). In the case of a veneer component 902 such as a stamped aluminum sheet metal veneer, the veneer thickness could be, for instance, as thin as 1/32 inch (0.794 centimeter), by way of example.

In this regard, the tiles 900 may be suitable for use in any number of indoor or outdoor applications where pathways needs to cover water lines. The tiles 900 can also be used to cover conduit that carries electrical wires, communications wires, network lines, data cables or other wired connections. For instance, the tiles 900 can be used in data centers, offices, commercial buildings, studios, and other environments where wires need to be run under the flooring. Moreover, the veneer component 902 can be selected to have a metal material, e.g., for conductivity, electromagnetic shielding or other suitable properties.

In certain illustrative implementations, polyvinyl chloride (PVC) or other material pipes, elbows, extensions, adapters can be placed in a mold such that the channels 906 can be formed directly around a network of pipes. Alternatively, the channels 906 can be open to the bottom of the tiles 900 so that the tiles 900 can be simply positioned over the existing pipes.

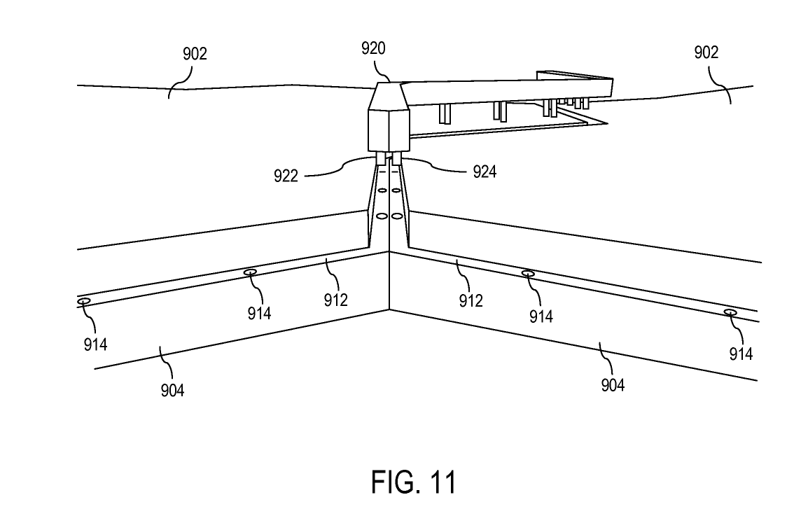

Referring to FIG. 11, in certain implementations, adjacent tiles 900 can be interconnected using a connector. For instance, as illustrated, two adjacent tiles 900 each include a wall 912 that extends around the circumference of the tile 900. As such, the circumference of the veneer component 902 may be smaller than the circumference of the foam component 904.

More particularly, the wall 912 is formed by the foam component 904, but not by the veneer component 902. The wall 912 includes spaced apart wells 914 along a top surface of the wall 912. A grout strip 920 has a profile that follows a contour (i.e., edge profile) of the tiles 900. Moreover, the grout strip 920 includes a plurality of legs 922 in a first column and a plurality of legs 924 in a second column that extend generally downward from the grout strip 920. The grout strip 920 “snaps” into the adjacent tiles 900 such that each of the plurality of legs is received into an associated well 914 of one of the tiles 900. The body width of the grout strip 920 spans between adjacent tiles 900 thus temporarily holding the tiles 900 together.

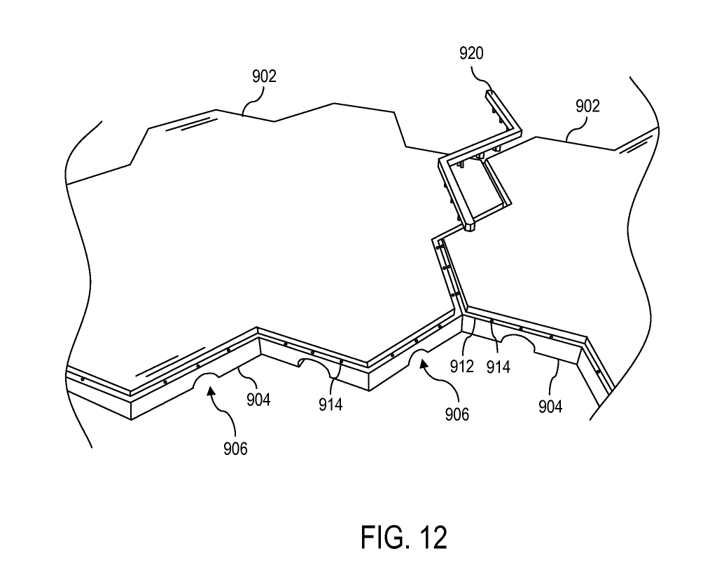

Referring to FIG. 12, another partial view of a pair of adjacent tiles 900 clarifies that the grout strip 920 follows the contour of adjacent tiles 900.

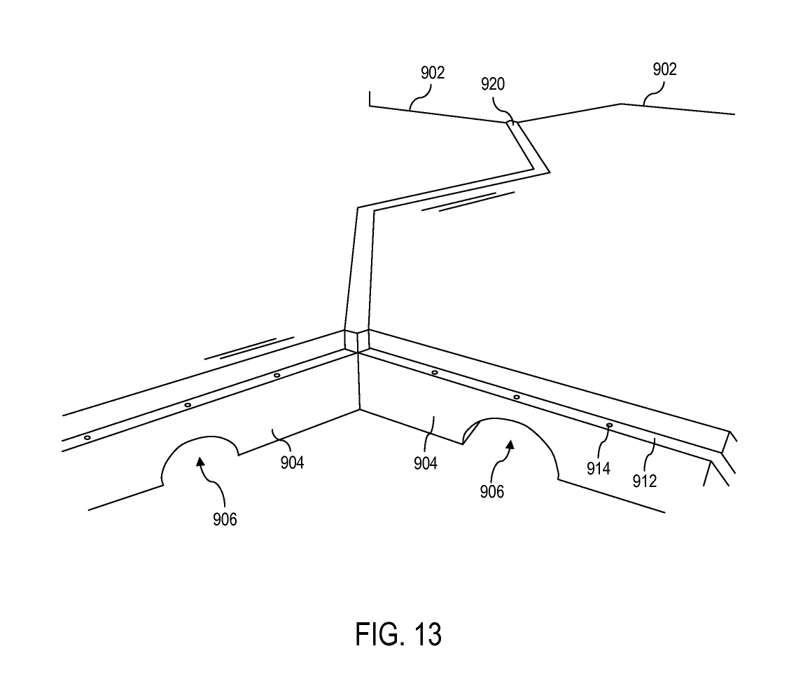

Referring to FIG. 13, the grout strip 920 of FIGS. 11 and 12 has been seated between two adjacent tiles 900. As illustrated, the grout strip 920 fills the gap between adjacent veneer components 902 caused by the walls 912 formed in the foam components 904. The grout strip 920 can be made of any material, including plastic, metal, wood, carbon fiber, or other materials, and forms a snap-in connector to couple adjacent tiles 900. Because adjacent tiles 900 are connected by the snap in connector, the tiles 900 can be removed, repaired, relocated, etc., without requiring special tools, machines, etc. In this regard, the grout connector 920 is removable and reusable. The grout connector 920 may include a reinforcing female edge into the mold that makes the grout connector 920 (or other strength additive structures), to prevent any long-term wear and tear on the foam.

For instance, in illustrative implementations, there is only ⅛ inch (0.3175 centimeters) recess on each tile 900, e.g., due to the thickness of the veneer component 902, so there is room for a 1/16 inch (0.159 centimeters) diameter hole. As such, the grout strip 920 may be ¼ inch (0.635 centimeter) wide and ¼ inch (0.635 centimeter) thick, with legs 922, 924 that protrude ¼ inch (0.635 centimeter) from the grout strip 920. Also, the male legs 922, 924 may have barbs or other features that snap fit into the wells 914.

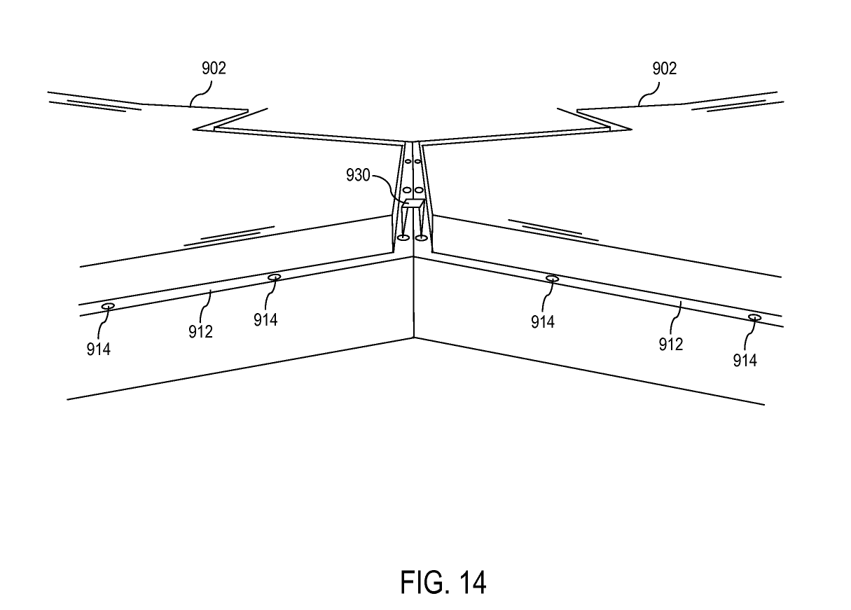

Referring to FIG. 14, in certain illustrative implementations, it may be desirable to use conventional grout between adjacent tiles 900. In this regard, pin 930 can be used to connect adjacent tiles 900. The pins 930 are generally shaped like staples. The pins 930 include a pair of legs and an interconnecting crown. The legs each connect to a corresponding one of a pair of tiles 900, and the crown bridges between the adjacent tiles 900. The crown sits flat against the wall 912, thus allowing conventional grout to fill the gap between adjacent veneer components 902. Where the pins 930 are not used, a traditional grout can be spread into the space between adjacent tiles 900. The grout would extend into the wells 914 thus creating a strong bond with the foam components 904.

According to further aspects of the present invention, the veneer component 902 may comprise a metal, wood or other material. For instance, brushed aluminum veneer may be used for green house applications to provide heat in winter. The pre-fabricated grout lines, e.g., via the walls 912, provide for easy install and tear down. Such an interconnection system also provides style options for grout line between the tiles 900. For instance, the grout can be aluminum, copper or any other material. The pre-fabricated grout strips 920 may be produced as interlocking 4′×8′ sections (1.21 meters×2.42 meters) that can be cut to a desired length, or the grout strips 920 may be jointed on the underside, e.g., allowing the grout strips 920 to be packaged in rolls for commercial customers.

Moreover, since the veneer component 902 is thin, conventional tile tools, such as saws, cutters, etc. have extended wear because there is less thickness of conventional tile material, e.g., stone, ceramic, porcelain, etc., to cut compared to conventional tiles. The foam component 904, which accounts for a majority of the thickness of the tile, is cut easily with conventional saws.

In yet further illustrative implementations, there may be no wall 912 for connectors. That is, the circumference of the veneer component 902 is the same as the circumference of the foam component 904. In this implementation, a “grout-less” connection between adjacent tiles 900 may be made using a suitable adhesive. Moreover, adhesive may alternatively be used to couple the tiles 900 to a floor surface.

Because the foam is rigid and hard, yet light weight, the tiles 900 are suitable for indoor as well as outdoor applications. Thus, the tiles 900 can be used for landscape tiles. For instance, the veneer component 902 may comprise concrete for outdoor applications such as decks or swimming pools where water lines can run underneath the tiles 900.

Moreover, the floor tiles 900 can be used to create radiant heat systems, even where there is no basement or substructure because the water lines can run directly through the foam components 904. Because of the thermal properties of the foam components, the heat can be efficiently directed and towards the radiant surface, e.g., the veneer component 902 to provide a more efficient radiant heating system.

Still further, although discussed with regard to floor tiles, the tiles 900 can be adapted for roof tiles and/or other construction configurations including wall tiles, etc.

The tiles 900 described with reference to FIGS. 9-14 can be used as described, or the tiles 900 can be combined with other features, techniques and constructions described more fully herein with regard to FIGS. 1-8 so as to produce complex tile configurations.

As a few illustrative but non-limiting examples, a first method is provided for creating a tile 900. The method comprises forming a veneer component 902 having a predetermined shape defining a top (top surface) of the tile 900. The method also comprises mixing a polyol and an isocyanate to create a foam pattern mixture, e.g., in a manner analogous to that set forth in greater detail herein, e.g., with reference to FIGS. 1 and 2. The method also comprises using the foam pattern mixture for forming a foam component 904 defining a foam base of the tile 900. Here, the foam component 904 is comprised of a rigid closed-cell structure having a skin so as to be strong, rigid and hard.

The foam may have a relatively large density, yet still be light weight compared to conventional materials for tiles, e.g., marble, slate, granite and other stones. The method also comprises laminating the veneer component 902 to the skin (e.g., the outside of the skin) of the foam component 904. The method also comprises providing at least one channel 906 entirely through the foam component 904 so as to provide a passageway under the veneer component 902 and through the foam component 904. The channel(s) 906 may be formed directly in the foam component 904 during a molding operation. Alternatively, post-mold work may be performed, e.g., to drill, route or otherwise remove material to form the channel(s) 906.

The veneer component 902 can be formed by shaping a substrate, e.g., metal, stone, ceramic, etc., to have any desired tile shape. In this regard, laminating the veneer component 902 to the outside skin of the foam component 904 may be accomplished by inserting the shaped substrate into a mold defining the shape of the foam base and inserting the foam pattern mixture into the mold so that the foam pattern mixture cures to the defined shape of the foam base and laminates to the veneer component 902.

In certain illustrative implementations of the method, using the foam pattern mixture for forming a foam component 904 may comprise shaping the foam component as a polygon having a combination of convex and concave angles such that the shape defines a plurality of arms and recesses such that when two or more tiles 900 are assembled together, the respective arms mate and interconnect with respective recesses, thus locking adjacent tiles 900 together. As another example, using the foam pattern mixture for forming a foam component 904 may comprise shaping the foam component as a polygon having a plurality of side faces such that at least one channel extends through each face of the foam component 904 defining a plurality of interconnected channels 906 through the foam component 904.

As noted particularly with regard to FIGS. 11-13, the method may further comprise using the foam pattern mixture for forming a foam component such that the foam component has a wall that extends past the circumference of the veneer component 902, the wall having a top surface with a plurality of wells therein. For instance, the method may comprise providing a grout strip 920 comprised of a shape corresponding to the circumference of the foam component, the grout strip 920 having a plurality of legs, each leg for receiving a corresponding well of a tile 900 to which the grout strip 920 is applied.

According to still further aspects, the first method may further comprise using the foam pattern mixture for forming a first closed-cell foam pattern having a skin, using the foam pattern mixture for forming a second closed-cell foam pattern having a skin, and laminating the first foam pattern to the second foam pattern such that a portion of the skin that forms on the second foam pattern adheres to a portion of the skin of the first foam pattern, thus defining the foam component 904.

Yet further, according to certain illustrative implementations, the first method may further comprise forming a veneer component 902 by forming a foam sheet, applying a print layer over the foam sheet, and applying a coating over the print layer.

In still a further variation of the first method, laminating the veneer component 902 to the outside skin of the foam component 904 may comprise inserting the veneer component 902 as discontinuous layer of pulverized material into a mold defining the shape of the foam base and inserting the mixture into the mold so that the foam mixture cures to a desired shape of the foam base and laminates to the veneer component 902 so that the veneer structure takes on a solid state.

In a further variation of the first method, the veneer component 902, the foam component 904 or both may comprise a coating. As an example, the method may further comprise laminating the coating to at least a portion of the outside skin of the first closed-cell foam pattern, such as by spraying the coating to an inside surface of the mold, and then inserting the mixture into the mold such that as the mixture forms the closed-cell foam pattern, the coating laminates to the skin. The coating can be alternatively applied by spraying directly over the veneer component 902.

As yet another illustrative example, a second method for creating a tile 900 is provided. The method comprises forming a veneer component 902 having a predetermined shape defining a top (surface) of the tile 900. The method also comprises mixing a polyol and an isocyanate to create a foam pattern mixture and using the foam pattern mixture for forming a foam component 904 defining a foam base of the tile 900. In this regard, the foam component 904 is comprised of a rigid closed-cell structure having a skin. Moreover, the veneer component 902 is laminated to the foam component 904. In this method, the foam component 904 is constructed so as to have a wall 912 that extends past the circumference of the veneer component 902, the wall 912 having a top surface with a plurality of wells 914 therein.

The second method may further comprise providing a grout strip 920 comprised of a shape corresponding to a contour of the foam component 904, the grout strip 920 having a plurality of legs, each leg for receiving a corresponding well of a tile 900 to which the grout strip 920 is applied.

The second method may further comprise forming a veneer component 902 by shaping a substrate to have a desired tile shape. In this regard, laminating the veneer component 902 to the skin (e.g., outside surface of the skin) of the foam component 904 may be accomplished by inserting the shaped substrate into a mold defining the shape of the foam base and by inserting the foam pattern mixture into the mold so that the foam pattern mixture cures to a desired shape of the foam base and laminates to the veneer component 902.

The second method may also comprise using the foam pattern mixture for forming a foam component 904 by shaping the foam component 904 as a polygon having a combination of convex and concave angles such that the shape defines a plurality of arms and recesses such that when two or more tiles 900 are assembled together, the respective arms mate and interconnect with respective recesses, thus locking adjacent tiles together.

As yet a further example, the second method may further comprise providing at least one channel entirely through the foam component 904 so as to provide a passageway under the veneer component 902 and through the foam component 904. In this regard, using the foam pattern mixture for forming a foam component 904 comprises shaping the foam component 904 as a polygon having a plurality of side faces such that at least one channel extends through each face of the foam component 904 defining a plurality of channels through the foam component 904.

Miscellaneous

The methods described above can be used to produce insulating veneer (exterior or interior) panels, e.g., for a commercial building or residential home. As above, a VIP can be encapsulated in a closed-cell foam compartment to attain high R-Values. However, even without the use of a VIP, the R-Value of the composite foam pattern panels are typically higher than current veneer products including, brick, stone, vinyl, and wood. For instance, according to aspects of the present disclosure, faux stone panel without the VIPs may provide insulation values of R-4 to R-24 depending on the foam panel's density and thickness. However, with the VIPs, the insulation value of the wall panels can be raised significantly to R-25 to R-60 or even higher.

The veneer foam panels herein may be produced by coating the mold with a hard coating (shore 65+), then inserting the dense foam in the mold to complete the veneer part. In some cases where higher R-Values are sought, a VIP can be inserted into a slot that was created in the mold. However, another process can be used to produce veneer foam panels.

In certain illustrative implementations, the internal surface of the mold can be coated with a clear coating where pulverized stone or other aesthetic texture/powder is added into the mold and sticks to the coating. Thus, when the foam is inserted into the mold, the pulverized stone is embedded on the surface of the resulting panel, giving the panel a faux-stone look, feel, and texture. In this regard, the processes described herein can be implemented generally to apply texture to a surface by integrating textural features to the inside mold cavity. Any features created in the mold are reproduced when using an in-mold coating, thus allowing faux-wood and other surface textures to be part of the mold itself.

As yet another example, the materials formed using techniques described herein, e.g., to form house siding, decking materials or other construction materials can be drilled, tapped or otherwise worked. Still further, as noted in greater detail herein, surface coatings can be applied in-mold or post-mold to provide a composite structure that exhibits strength as well as wear resistance, corrosion resistance, weather proofing, UV protection, and protection from delaminating or discoloring. Thus, a composite foam product formed into a siding for a house or other structure can withstand various weather conditions, including a hail storm. More particularly, the foam composite structure will be damage resistant from hail or other impacts caused by adverse environmental conditions.

Also, it is possible to embed usable tools, such as bolts, clamps, fittings and other devices to assemble, interlock or otherwise connect work pieces formed of foam pattern components together. The foam materials can be threaded, tapped etc., or threaded inserts can be installed in the foam material. Still further, threads, etc., can form part of the mold cavity shape itself, thus forming the threaded features as the foam mixture cures in the mold. Still further, the foam pattern, or overall laminated foam pattern and outer layer(s) can be worked, e.g., sanded, cut, glued, etc. to finish or build large complex structures. Thus the panels can be installed by gluing, nailing, screwing, or other attachment tools. The sides of the panels can have tongue and groove means of attaching to each other or other such features for overlap or snap fit or gluing to attach adjacent panels.

Due to the stiffness and overall light weight of the foam described herein, and using the techniques herein to form laminated structures so as to increase stiffness and strength, products can be manufactured that are decorative, used for construction, used for architectural purposes, or combinations thereon. Thus, items such as fences, planters, window panes, benches, stools, tables, decks, etc., can be manufactured.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. Aspects of the invention were chosen and described in order to best explain the principles of the invention and the practical application, and to enable others of ordinary skill in the art to understand the invention for various embodiments with various modifications as are suited to the particular use contemplated.

What is claimed is:

1. A method for creating a tile, the method comprising:
forming a veneer component having a predetermined shape defining a top of the tile;
mixing a polyol and an isocyanate to create a foam pattern mixture;
using the foam pattern mixture for forming a foam component defining a foam base of the tile, the foam component comprised of a rigid closed-cell structure having a skin;
laminating the veneer component to the skin of the foam component; and
providing the foam component so as to have at least one channel entirely through the foam component defining a passageway under the veneer component and through the foam component.

2. The method of claim 1, wherein:
forming a veneer component comprises:
shaping a substrate to have a desired tile shape; and
laminating the veneer component to the skin of the foam component comprises:
inserting the substrate into a mold defining the shape of the foam base; and
inserting the foam pattern mixture into the mold so that the foam pattern mixture cures to the defined shape of the foam base and laminates to the veneer component.

3. The method of claim 1, wherein:
using the foam pattern mixture for forming a foam component comprises:
shaping the foam component as a polygon having a combination of convex and concave angles such that the shape defines a plurality of arms and recesses such that when two or more tiles are assembled together, the respective arms mate and interconnect with respective recesses, thus locking adjacent tiles together.

4. The method of claim 1, wherein:
using the foam pattern mixture for forming a foam component comprises:
shaping the foam component as a polygon having a plurality of side faces such that at least one channel extends through each face of the foam component defining a plurality of interconnected channels through the foam component.

5. The method of claim 1 further comprising:
using the foam pattern mixture for forming a foam component such that the foam component has a wall that extends past a circumference of the veneer component, the wall having a top surface with a plurality of wells therein.

6. The method of claim 5 further comprising:
providing a grout strip comprised of a shape corresponding to a contour of the foam component, the grout strip having a plurality of legs, each leg for receiving a corresponding well of a tile to which the grout strip is applied.

7. The method of claim 1 wherein using the foam pattern mixture for forming a foam component comprises:
using the foam pattern mixture for forming a first closed-cell foam pattern having a skin;
using the foam pattern mixture for forming a second closed-cell foam pattern having a skin;
laminating the first foam pattern to the second foam pattern such that a portion of the skin that forms on the second foam pattern adheres to a portion of the skin of the first foam pattern, thus defining the foam component.

8. The method of claim 1 wherein:
forming a veneer component comprises:
forming a foam sheet;
applying a print layer over the foam sheet; and
applying a coating over the print layer.

9. The method of claim 1 wherein:
laminating the veneer component to the foam component comprises:
inserting the veneer component as discontinuous layer of pulverized material into a mold defining the shape of the foam base; and
inserting the foam pattern mixture into the mold so that the foam mixture cures to a desired shape of the foam base and laminates to the veneer component so that the veneer structure takes on a solid state.

10. A method for creating a tile, the method comprising:
forming a veneer component having a predetermined shape defining a tile top;
mixing a polyol and an isocyanate to create a foam pattern mixture;
using the foam pattern mixture for forming a foam component defining a foam base of the tile, the foam component comprised of a rigid closed-cell structure having a skin; and
laminating the veneer component to the skin of the foam component;
wherein:
the mixture forms a foam component such that the foam component has a wall that extends past a circumference of the veneer component, the wall having a top surface with a plurality of wells therein.

11. The method of claim 10 further comprising:
providing a grout strip comprised of a shape corresponding to a contour of the foam component, the grout strip having a plurality of legs, each leg for receiving a corresponding well of a tile to which the grout strip is applied.

12. The method of claim 10, wherein:
forming a veneer component comprises:
shaping a substrate to have a desired tile shape; and
laminating the veneer component to the skin of the foam component comprises:
inserting the shaped substrate into a mold defining the shape of the foam base; and
inserting the foam pattern mixture into the mold so that the foam mixture cures to the defined shape of the foam base and laminates to the veneer component.

13. The method of claim 10, wherein:
using the foam pattern mixture for forming a foam component comprises:
shaping the foam component as a polygon having a combination of convex and concave angles such that the shape defines a plurality of arms and recesses such that when two or more tiles are assembled together, the respective arms mate and interconnect with respective recesses, thus locking adjacent tiles together.

14. The method of claim 10 further comprising:
providing at least one channel entirely through the foam component so as to provide a passageway under the veneer component and through the foam component;
wherein:
using the foam pattern mixture for forming a foam component comprises:
shaping the foam component as a polygon having a plurality of side faces such that at least one channel extends through each face of the foam component defining a plurality of channels through the foam component.

15. A method for creating a structure, the method comprising:
inserting a first layer into a mold;
mixing a first polyol and a first isocyanate to create a first foam pattern mixture; and
inserting the first foam pattern mixture into the mold such that the first foam pattern mixture forms a first closed-cell foam pattern having a skin that laminates to the first layer to form a composite foam pattern structure.

16. The method of claim 15, wherein the first layer comprises a continuous layer, further comprising laminating the continuous layer to at least a portion of the skin of the first closed-cell foam pattern.

17. The method of claim 15, wherein the first layer comprises a discontinuous layer, further comprising laminating the discontinuous layer to at least a portion of the skin of the first closed-cell foam pattern.

18. The method of claim 15, wherein the first layer comprises a coating, further comprising laminating the coating to at least a portion of the skin of the first closed-cell foam pattern by spraying the coating to an inside surface of the mold, and then inserting the mixture into the mold such that as the mixture forms the closed-cell foam pattern, the coating laminates to the skin.

19. The method of claim 15 further comprising:
mixing a second polyol and a second isocyanate to create a second foam pattern mixture;
forming a second closed-cell foam pattern having a skin; and
laminating the first foam pattern to the second foam pattern such that a portion of the skin that forms on the second foam pattern adheres to a portion of the skin of the first foam pattern.

20. The method of claim 19, wherein:
the first foam pattern mixture is structurally identical to the second foam pattern mixture such that the first foam pattern has structural properties that are similar to the second foam pattern.
